(19) United States
(12) Patent Application Publication
(10) Pub. No.: US 2016/0320239 A1
(43) Pub. Date: Nov. 3, 2016

(54) INFRARED SENSOR MODULE USING ROTARY ULTRASONIC MOTOR

(71) Applicant: ECO DM LAB CO., LTD., Cheogju-si (KR)

(72) Inventor: Man-Soon Yoon, Cheongju-si, Chungcheongbuk-do (KR)

(21) Appl. No.: 15/103,647

(22) PCT Filed: Dec. 10, 2014
(86) PCT No.: PCT/KR2014/012129

§ 371 Date: Jun. 10, 2016

(30) Foreign Application Priority Data
Dec. 11, 2013 (KR) 10-2013-0154032

(51) Int. Cl. G01J 5/02; G01J 5/00; G01J 5/08

(52) U.S. Cl. CPC G01J 5/0205; G01J 5/0806; G01J 5/0025; G08B 13/193

(57) ABSTRACT

An infrared sensor module utilizing a rotary ultrasonic motor is disclosed. The infrared sensor module utilizing a rotary ultrasound motor according to one embodiment of the present invention comprises: an infrared sensor for detecting an object that radiates infrared rays; a rotary ultrasonic motor including a piezoelectric diaphragm having a partitioned electrode structure in a pinwheel shape in a plate body formed with a piezoelectric material and a ring-shaped rotator driven by torsional vibrations generated along the side surfaces of the piezoelectric diaphragm; a Fresnel lens rotatably provided by being coupled to the rotator to control intermittent blocking of the infrared rays incident in the front direction of the infrared sensor; an oscillation unit for outputting a square wave required for the rotary ultrasonic motor; and a control unit for controlling the oscillation unit by using a signal detected by the infrared sensor and controlling the driving of the rotary ultrasonic motor.

### CROSS-REFERENCE TO RELATED APPLICATION(S)

This application claims priority from Korean Patent Application No. 10-2013-0154032, filed on Dec. 11, 2013, in the Korean Intellectual Property Office, the disclosure of which is incorporated herein by reference in its entirety.

### BACKGROUND

1. Field

One embodiment of the present invention relates to an infrared sensor module and, more specifically, to an infrared sensor module utilizing a rotary ultrasonic motor for which periodic rotation is possible utilizing a rotary ultrasonic motor, low voltage driving is possible, and continuous detection of a signal is possible even from a stationary infrared ray radiating object.

2. Description of Related Art

As is well known, a pyroelectric infrared sensor utilizes the pyroelectric characteristic of a pyroelectric material and, based on Blackbody radiation, utilizes a temperature change resulting from absorption of radiated infrared ray energy.

Being capable of detecting infrared rays radiating from a human body, the pyroelectric infrared sensor is most frequently used in human body detection and is actively utilized in automated lighting systems, automated door opening and closing, automatic water dispensing apparatus, intruder alarms, etc. Also, application extends to different kinds of gas detection equipment, toxic gas alarm systems, fire alarm systems, etc. that utilize infrared ray absorption.

However, because the pyroelectric infrared sensor detects a transitional temperature change, once the pyroelectric material gains stability after a temperature change, further output is not detected.

In other words, signal is generated only for an initial receiving of infrared rays, and no further output signal is generated afterwards in the case of a still present but stationary heat source.

For this reason, the pyroelectric infrared sensor has a critical problem in terms of applicable areas.

For example, numerous lights equipped with pyroelectric infrared sensors are installed in bathrooms, in apartment foyers, for basement stairs, etc., and a shortcoming exists for such lights where although a light initially turns on when a person appears, the light turns off after a certain elapsed time even though the person is still present.

FIG. 1 is a perspective view of a conventional pyroelectric infrared sensor consisting of piezoelectric bimorphs and slits. In FIG. 1, a silicon window 10 that selectively transmits infrared rays is installed at the top of a cap 11. Infrared rays (IR) enters through the silicon window 10.

Blocking of the infrared rays that have entered is controlled by slit plates 14 and 14′ disposed at free ends of piezoelectric bimorphs. Further, the infrared rays are incident on a pyroelectric device 15 after passing through a circular hole 17 at the top of a shield box 16 within which the pyroelectric device 15 is installed. Accordingly, a voltage proportional to infrared ray intensity may be detected.

The operating principle of controlled blocking of infrared rays in a pyroelectric infrared ray sensor can be seen in FIG. 2. First, as seen in (a) of FIG. 2, when an initially applied voltage is 0V, upper slit plate 14′ and lower slit plate 14 are aligned so that infrared rays (IR) can pass. However, when a voltage is applied to the piezoelectric bimorphs, as shown in (b) of FIG. 2, the upper slit plate 14′ and the lower slit plate 14 become staggered with respect to each other so that infrared rays (IR) can be blocked.

In such a structure, because incident light is reduced by about a half due to the blocking surface of the slit plate, that is, other than the slit openings, there is a shortcoming in which the output voltage proportional thereto is also reduced by about a half

Also, in case manufacturing precision of slits of a slit plate is not high, blocking-level variation is large, cost of manufacturing the slits is high, and manufacturing slits suitable for a piezoelectric bimorph whose end actually executes a circular arc motion rather than a linear motion is difficult. Further, there is a manufacturing difficulty associated with requiring two piezoelectric bimorphs that have perfectly matched size and piezoelectric characteristics.

Further, because a hole is formed at the top of a shield box within which an infrared ray sensor is installed and air currents are generated due to slit plates installed at the ends of the piezoelectric bimorphs moving left and right, there is a problem of increased noise.

The reason for these problems is an inadequate displacement of a piezoelectric bimorph, and although research is underway for increasing the displacement, structural complexities have caused a difficulty for commercial adaptation.

### SUMMARY

One embodiment of the present invention provides an infrared sensor module utilizing a rotary ultrasonic motor for which periodic rotation is possible, low voltage driving is possible, and continuous detection of a signal is possible even from a stationary infrared ray radiating object while having a relatively simple integrated structure due to utilizing a rotary ultrasonic motor.

Such a rotary ultrasonic motor does not generate electromagnetic waves and satisfies a requirement that the magnitude of temperature increase relative to ambient temperature due to driving of a piezoelectric diaphragm of a rotary ultrasonic motor does not increase by more than 1° C.

According to one embodiment of the present invention, an infrared sensor module utilizing a rotary ultrasonic motor is provided that includes an infrared sensor for detecting an object that radiates infrared rays, a rotary ultrasonic motor including a piezoelectric diaphragm having a partitioned electrode structure in a pinwheel shape in a plate body formed with a piezoelectric material and a ring-shaped rotator that is driven by torsional vibrations generated along the side surfaces of the piezoelectric diaphragm, a Fresnel lens rotatably provided by being coupled to the rotator for intermittent blocking of infrared rays incident in the front direction of the infrared sensor, an oscillation unit that outputs a square wave necessary for the rotary ultrasonic motor, and a control unit that controls the oscillation unit using a signal detected by the infrared sensor and thereby controls driving of the rotary ultrasonic motor.

A booster unit that adjusts a square wave output from the oscillation unit to a suitable voltage for the rotary ultrasonic motor may further be included.

The control unit may control the oscillation unit to rotate the rotary ultrasonic motor when a signal at or above a reference level is delivered from the infrared sensor, and the control unit may control the oscillation unit to stop the rotation of the rotary ultrasonic motor when a signal below a reference level is delivered from the infrared ray sensor.

The control unit may turn off a power supply for the oscillation unit when no signal is received from the infrared sensor for a length of time exceeding a preset length.

When a square wave from the oscillation unit with a driving frequency at or above a preset frequency is applied to the rotary ultrasonic motor, the piezoelectric diaphragm may be configured such that torsional vibrations are generated in the piezoelectric diaphragm so that the rotator is rotated by an angle corresponding to the number of pulses of the applied square wave.

A plurality of holes may be provided for leading electrical wires lower for delivering electrical signals of parts that are assembled in the rotary ultrasonic motor.

The operational amplifier that amplifies a signal from the infrared sensor may further be included, and the operational amplifier and the infrared sensor together may be installed on top of the rotary ultrasonic motor.

A case that is assembled with the rotator and formed such that the focusing distance between the infrared sensor and the Fresnel lens is adjustable may further be included.

The Fresnel lens may utilize alternatingly distributed activating and deactivating domains on the surface, and the central region may be configured with a deactivating domain.

The Fresnel lens may be formed such that, by rotating due to the rotary ultrasonic motor, intermittent blocking of the entire infrared rays incident on the infrared sensor is possible.

### BRIEF DESCRIPTION OF THE DRAWINGS

FIG. 1 is a perspective view of a pyroelectric infrared ray sensor consisting of piezoelectric bimorphs and slits.

FIG. 2 is a concept diagram illustrating operating principles of controlled blocking of infrared rays in the pyroelectric infrared ray sensor shown in FIG. 1.

FIG. 3 is a configurational diagram for a pyroelectric infrared ray sensor module utilizing a rotary ultrasonic motor according to one embodiment of the present invention.

FIG. 4 is a detailed configurational diagram for a pyroelectric infrared ray sensor module utilizing a rotary ultrasonic motor according to one embodiment of the present invention.

FIG. 5 illustrates example forms of a Fresnel lens that is utilizable in a pyroelectric infrared ray sensor module utilizing a rotary ultrasonic motor according to one embodiment of the present invention.

FIGS. 6 to 8 are diagrams illustrating using a pyroelectric infrared ray sensor module utilizing a rotary ultrasonic motor according to one embodiment of the present invention.

FIG. 9 is a graph showing a result of measuring temperature change during a 1000 hr of continuous operation of a pyroelectric infrared ray sensor module utilizing a rotary ultrasonic motor according to one embodiment of the present invention.

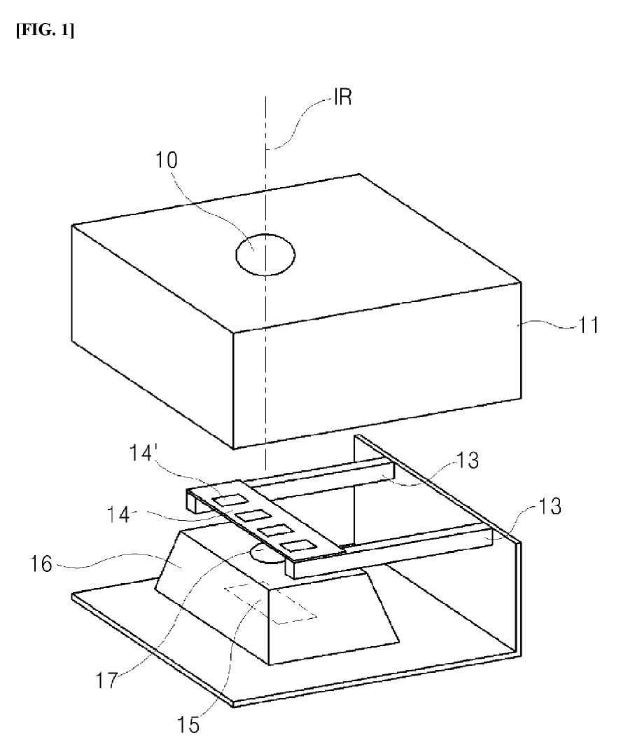

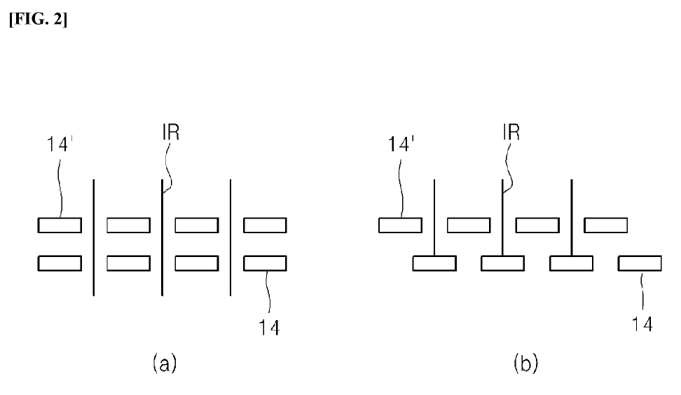

### DETAILED DESCRIPTION

Hereinafter, an infrared ray sensor module utilizing a rotary ultrasonic motor according to one embodiment of the present invention will be described in detail with reference to accompanying drawings.

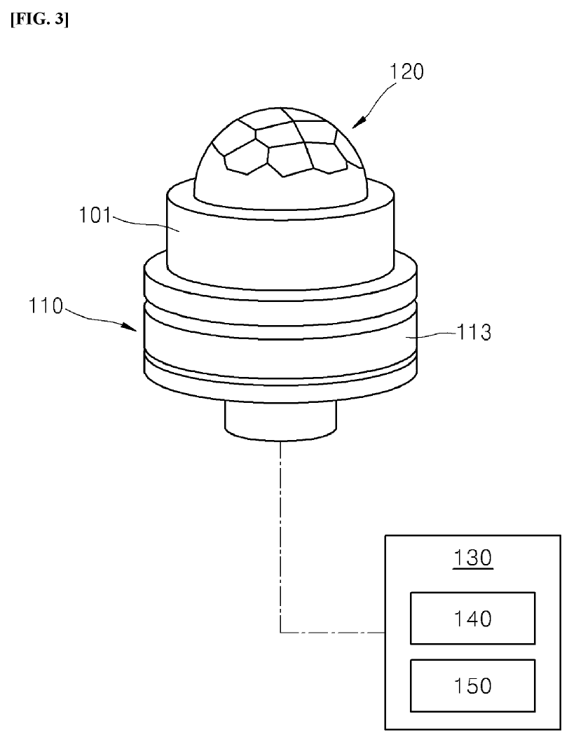

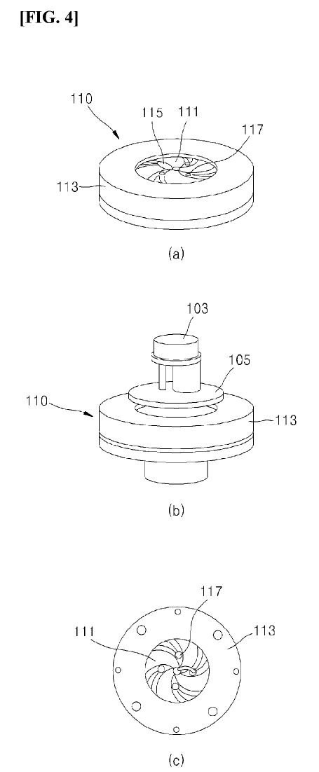

FIG. 3 is configurational diagram for an infrared ray sensor module utilizing a rotary ultrasonic motor according to one embodiment of the present invention, and FIG. 4 is a detailed configurational diagram for an infrared ray sensor module utilizing a rotary ultrasonic motor according to one embodiment of the present invention.

Referring to FIGS. 3 and 4, an infrared ray sensor module utilizing a rotary ultrasonic motor according to one embodiment of the present invention (hereinafter, simply “infrared ray sensor module”) 100 includes an infrared ray sensor 103, a rotary ultrasonic motor 110, a Fresnel lens 120, an oscillation unit 140, and a control unit 130.

As is commonly known, the infrared ray sensor 103 is a device that utilizes infrared rays to convert a physical or chemical parameter including a temperature, a pressure, a radiation level, etc. into an electrical level that can be signal processed.

The rotary ultrasonic motor 110 includes a piezoelectric diaphragm 111 having a partitioned electrode structure in a pinwheel shape in a plate body formed with a piezoelectric material and a ring-shaped rotator 113 that is driven by torsional vibrations generated along the side surfaces of the piezoelectric diaphragm.

The Fresnel lens 120 corresponds to a component rotatably provided by being coupled to the rotator 113 for intermittent blocking of infrared rays incident in the front direction of the infrared sensor 103.

The oscillation unit 140 may be configured to output a square wave necessary for the rotary ultrasonic motor 110.

Further, preferably, a booster (not shown) may be further included that adjusts a square wave output from the oscillation unit 140 to a voltage suitable for the rotary ultrasonic motor 110.

The control unit 130 may be configured to control the oscillation unit using a signal detected by the infrared sensor and thereby control driving of the rotary ultrasonic motor.

Also, the control unit 130 may further include a sensor control unit 150 that controls the infrared ray sensor as shown in FIG. 3.

Also, the control unit 130 may control the oscillation unit 140 to rotate the rotary ultrasonic motor 110 when a signal at or above a reference level is delivered from the infrared sensor 103.

Further, the control unit 130 may control the oscillation unit 140 to stop the rotation of the rotary ultrasonic motor 110 when a signal below a reference level is delivered from the infrared ray sensor 103.

Also, the control unit 130 may be configured to turn off a power supply for the oscillation unit 140 when no signal is received from the infrared sensor 103 for a length of time exceeding a preset length.

Meanwhile, a case may be examined in which a square wave with a driving frequency at or above a preset frequency from the oscillation unit 140 is applied to the rotary ultrasonic motor 110.

In this case, torsional vibrations are generated in the piezoelectric diaphragm 111 so that the rotator 113 may be rotated by an angle corresponding to the number of pulses of the applied square wave.

In (a) of FIG. 4, the structure of a rotary ultrasonic motor 110 is illustrated.

The rotary ultrasonic motor 110 includes a piezoelectric diaphragm 111 having a partitioned electrode structure in a pinwheel shape in a plate body formed with a piezoelectric material and a ring-shaped rotator 113 that is driven by torsional vibrations generated along the side surfaces of the piezoelectric diaphragm 111.

Also, (b) in FIG. 4, an operational amplifier 105 may further be included as a component that amplifies a signal from the infrared ray sensor 103.

Preferably, the operational amplifier 105 may be provided in a structure in which the operational amplifier 105 and the infrared sensor 103 together are installed on top of the rotary ultrasonic motor 110.

Also, in (c) of FIG. 4, a plurality (for example: 4 holes) of holes 117 can be seen that is provided for leading wires lower for delivering electrical signals of parts that are assembled in the rotary ultrasonic motor 110.

Also, again in (a) of FIG. 4, a plurality (for example: 3 terminals) of terminals that input and output all electrical signals for the rotary ultrasonic motor 110 passes through a plurality of holes 115 to be extracted below the rotary ultrasonic motor 110 and may again be connected to the control unit 130.

Further, a case 101 in the form of covering the top of the rotary ultrasonic motor 110 may be provided.

The case 101 may be provided in a form shown in FIG. 3 as an example and may also be provided in a slightly varied form and structure without a problem.

Also, the case 101 may be assembled with the rotary ultrasonic motor 110 (more specifically, rotator 113).

Additionally, the case 101 may be configured such that the focusing distance between the infrared sensor 103 and the Fresnel lens 120 is adjustable.

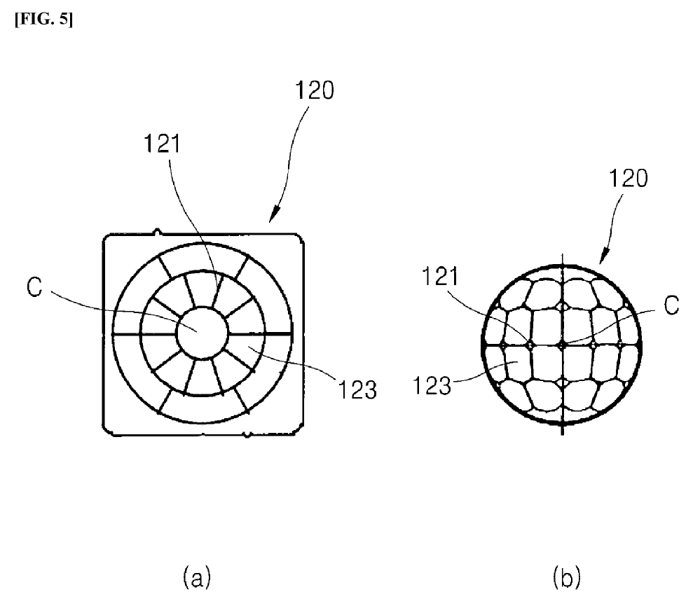

FIG. 5 illustrates example forms of a Fresnel lens that is utilizable in a pyroelectric infrared ray sensor module utilizing a rotary ultrasonic motor according to one embodiment of the present invention.

The Fresnel lens shown in FIG. 5 has two forms (that is, distinguished into (a) of FIG. 5 and (b) of FIG. 5). The difference between the two forms will be used to explain the structure and the effects of the Fresnel lens.

The illustrated Fresnel lens 120 may include a cell (hereinafter, “activating domain 123”) for focusing infrared rays radiated from an object that radiates infrared rays (example: a human body) on an infrared ray sensor and a cell (hereinafter, “deactivating domain 121”) for blocking and thus preventing infrared rays from being focused on the infrared ray sensor by being provided in the border areas between activating domains 123.

The activating domains 123 and deactivating domains 121 may be distributed with a uniform spacing and may be configured in the forms shown in (a) and (b) of FIG. 5.

However, there is a difference between the distribution structures of the activating and deactivating domains of the Fresnel lens 120 shown in (a) and (b) of FIG. 5.

That is, in the case of the Fresnel lens 120 shown in (b) of FIG. 5, a distinguishing feature is that no activating domain exists in the central region (C) unlike the case shown in (a) of FIG. 5.

As aforementioned, infrared rays may not be detected when infrared rays are input through the deactivating domain 121, and infrared rays may be detected when infrared rays are input through the activating domain 123.

For more effective intermittent blocking of the infrared rays, the activating domain 123 and deactivating domain 121 of the Fresnel lens 120 need to be alternated by being linked with the rotary ultrasonic motor's movement.

However, according to the structure of the Fresnel lens shown in (a) of FIG. 5, because the activating domain 123 is formed in the central region (C) of the Fresnel lens, intermittent infrared ray blocking function cannot be effective.

On the other hand, in the case of the Fresnel lens shown in (b) of FIG. 5, not only are the activating domain 123 and deactivating domain 121 uniformly distributed, the Fresnel lens, in particular, is provided with a structure with no activating domain (123) in the central region (C).

Accordingly, by using Fresnel lens 120 in (b) of FIG. 5, when the rotator of the rotary ultrasonic motor rotates the Fresnel lens 120, entire infrared rays incident on the infrared ray sensor may be intermittently blocked.

For these reasons, it is preferable that the Fresnel lens according to one embodiment of the present invention utilizes the structure shown in (b) of FIG. 5.

Next, a method of operating an infrared ray sensor module according to one embodiment of the present invention is briefly examined.

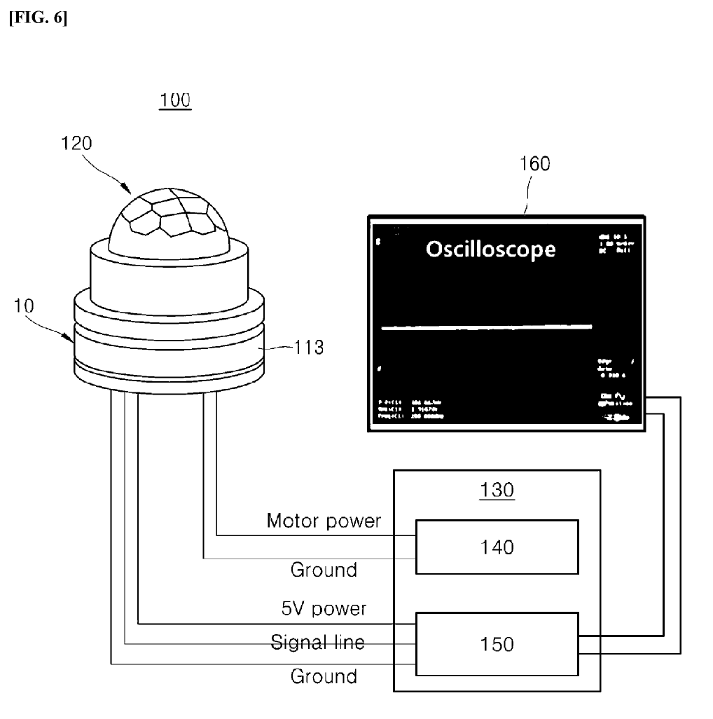

FIGS. 6 to 8 are diagrams illustrating using a pyroelectric infrared ray sensor module utilizing a rotary ultrasonic motor according to one embodiment of the present invention.

First, examining FIG. 6, a configuration is shown in which an oscilloscope 160 is connected to an infrared ray sensor module 100 that consists of an infrared ray sensor, a rotary ultrasonic motor 110, a Fresnel lens 120, an oscillation unit 140, a control unit 130 (including a sensor control unit 150), etc.

Using this, infrared rays radiating from an object that radiates infrared rays (for example: a human body) may be detected in real time.

In addition, using the oscilloscope 160, infrared ray sensor signal may easily be remotely monitored.

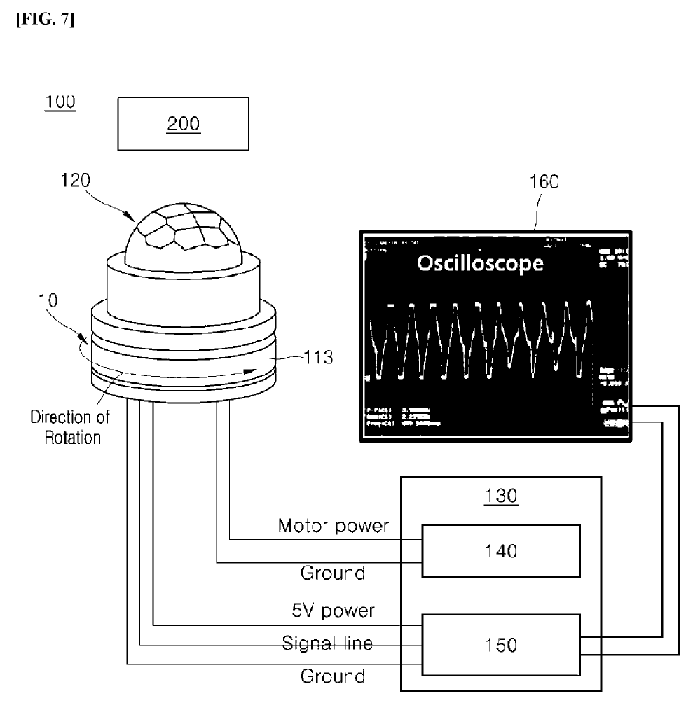

In FIG. 7, a case is shown in which an object that radiates infrared rays (hereinafter, as an example, “stationary human body”) 200 is detected by an infrared ray sensor module and caused the oscillation unit 140 to operate.

When a stationary human body 200 enters the detection range of infrared ray sensor module 100 and, more specifically, enters the detection range of the Fresnel lens 120, the output pulse waves from the oscillation unit 140 are periodically input to the rotary ultrasonic motor 110.

Then, the rotator 113 rotates in the direction of rotation. At this point, the activating domain and the deactivating domain of the Fresnel lens 120 rotate due to the rotating movement of the rotator 113 to intermittently block infrared rays incident infrared ray sensor.

Accordingly, the infrared rays radiating from the stationary body 200 is continuously incident on the infrared ray sensor, and the signal of the control unit 130, especially the signal read from the oscilloscope connected to the sensor control unit 150 is generated as a continuous signal (for example: 5 V peak to peak).

By this method, infrared rays radiating from a stationary object that radiates infrared rays such as a stationary human body 200 may be effectively detected even though not moving.

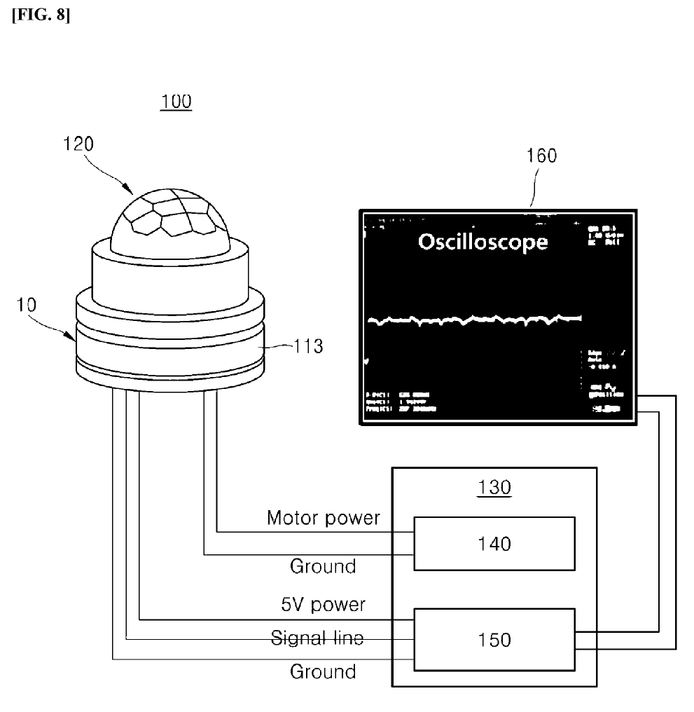

FIG. 8 is a diagram showing a case where there is no stationary human body 200. As shown, when a stationary human body does not exist within the detection range of the Fresnel lens 120, the rotary ultrasonic motor 110 may be driven to rotate the Fresnel lens 120.

In this case, noise signal obtained from the oscilloscope 160 connected to the sensor control unit 150 may be a very small value compared to FIG. 7 above (for example: 0.3 V peak to peak).

Also, the infrared ray sensor module 100 provided as in the above demonstrates effectiveness as a device capable of continuous detection of a stationary human body with an excellent S/N ratio (for example: S/N ratio greater than or equal to 16).

As described above, according to the constitution and operation of the present invention, by utilizing a rotary ultrasonic motor, there is an effect in which a relatively simple integrated structure is possible, a periodic rotation and a low voltage driving are possible, and continuous detection of a signal is possible even from a stationary infrared ray radiating object.

In particular, according to one embodiment of the presentation, there are advantages in which step driving is possible, driving with low electrical power, that is, less than 1 Watt, and driving at low voltage of 5-20 V are possible, and controlling noise such as electromagnetic noise which can be a source of noise or heat generation from the rotary ultrasonic motor to be less than or equal to 0.5° C. is possible.

In other words, due to being integrated together with a Fresnel lens in an isolated space, a rotary ultrasonic motor has an adverse effect on product performance by causing increased noise in an infrared ray sensor signal when temperature rises during movement of a rotary ultrasonic motor.

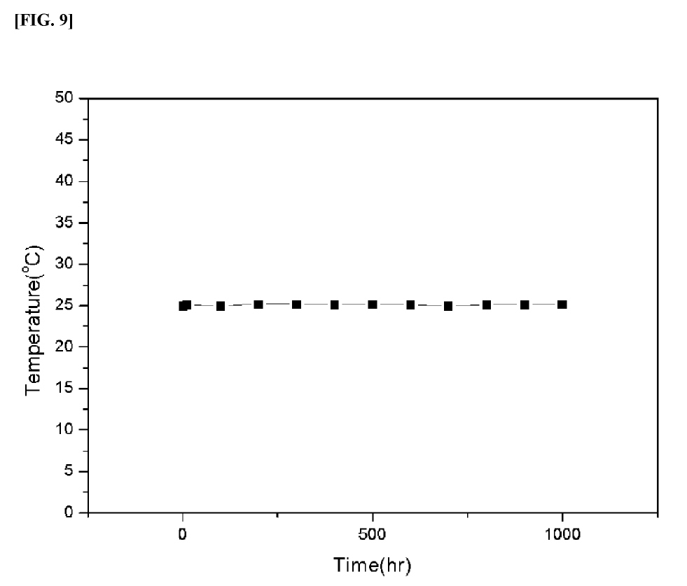

A result of measuring temperature changes of a rotary ultrasonic motor during continuously operating for 1000 hr is shown in FIG. 9. From the 1000 hr operation, it is thus easy to see that the temperature change is maintained below or at 0.5° C.

What is claimed is:

1. An infrared sensor module utilizing a rotary ultrasonic motor comprises:
an infrared sensor for detecting an object that radiates infrared rays;
a rotary ultrasonic motor including a piezoelectric diaphragm having a partitioned electrode structure in a pinwheel shape in a plate body formed with a piezoelectric material and a ring-shaped rotator that is driven by torsional vibrations generated along the side surfaces of the piezoelectric diaphragm;
a Fresnel lens rotatably provided by being coupled to the ring-shaped rotator for intermittent blocking of infrared rays incident in the front direction of the infrared sensor;
an oscillation unit that outputs a square wave necessary for the rotary ultrasonic motor; and
a control unit that controls the oscillation unit using a signal detected by the infrared sensor and thereby controls driving of the rotary ultrasonic motor;

2. The infrared sensor module of claim 1, further comprising a booster unit that adjusts a square wave output from the oscillation unit to a suitable voltage for the rotary ultrasonic motor.

3. The infrared sensor module of claim 1, wherein the control unit controls the oscillation unit to rotate the rotary ultrasonic motor when a signal at or above a reference level is delivered from the infrared sensor and the control unit controls the oscillation unit to stop the rotation of the rotary ultrasonic motor when a signal below a reference level is delivered from the infrared ray sensor.

4. The infrared sensor module of claim 1, wherein the control unit turns off a power supply for the oscillation unit when no signal is received from the infrared sensor for a length of time exceeding a preset length.

5. The infrared sensor module of claim 1, wherein a square wave from the oscillation unit with a driving frequency at or above a preset frequency is applied to the rotary ultrasonic motor, torsional vibrations are generated in the piezoelectric diaphragm so that the ring-shaped rotator is rotated by an angle corresponding to the number of pulses of the applied square wave.

6. The infrared sensor module of claim 1, wherein the piezoelectric diaphragm has a plurality of holes provided for leading electrical wires lower for delivering electrical signals of parts that are assembled in the rotary ultrasonic motor.

7. The infrared sensor module of claim 1, further comprising an operational amplifier that amplifies a signal from the infrared sensor and wherein the operational amplifier and the infrared sensor together are installed on top of the rotary ultrasonic motor.

8. The infrared sensor module of claim 1, further comprising a case that is assembled with the ring-shaped rotator and formed such that the focusing distance between the infrared sensor and the Fresnel lens is adjustable.

9. The infrared sensor module of claim 1, wherein the Fresnel lens utilizes alternatingly distributed activating and deactivating domains on a surface of the Fresnel lens and a central region of the Fresnel lens is configured with the deactivating domain.

10. The infrared sensor module of claim 9, wherein the Fresnel lens is formed such that, by rotating due to the rotary ultrasonic motor, intermittent blocking of the entire infrared rays incident on the infrared sensor is possible.
